(19) United States
(12) Patent Application Publication
(10) Pub. No.: US 2021/0035462 A1
(43) Pub. Date: Feb. 4, 2021

(54) METHODS OF REMOTE USER ENGAGEMENT AND INSTRUCTIONAL COOKING DEMONSTRATIONS

(71) Applicant: Haier US Appliance Solutions, Inc., Wilmington (DE)

(72) Inventors: Jeff Donald Drake, Louisville, KY (US); Jay Broniak, Louisville, KY (US)

(21) Appl. No.: 16/529,084

(22) Filed: Aug. 1, 2019

(51) Int. Cl. G09B 5/06; G09B 19/00; H04N 7/14

(52) U.S. Cl. CPC G09B 5/065; H04N 7/142; G09B 19/00

(57) ABSTRACT

Methods of directing an instructional demonstration at a remote device, as provided herein, may include transmitting a recipe data packet configured to initiate a user-guided presentation of a plurality of sequenced recipe panels at the remote device. The method may further include transmitting a video signal configured to initiate a real-time video feed at the remote device in tandem with the user-guided presentation and receiving a user-progress signal from the remote device. The user-progress signal may correspond to a currently-displayed recipe panel of the plurality of sequenced recipe panels at the remote device. The method may still further include presenting a panel marker at an instructor device spaced apart from the remote device. The panel marker may indicate the currently-displayed recipe panel at the remote device.

### FIELD OF THE INVENTION

The present subject matter relates generally to systems and methods for remote instructional demonstrations, particularly for cooking at or near a residential cooking appliance.

### BACKGROUND OF THE INVENTION

Cooking appliances, such as cooktop or range appliances, generally include heating elements for heating cooking utensils, such as pots, pans and griddles. A variety of configurations can be used for the heating elements located on the cooking surface of the cooking appliance. The number of heating elements or positions available for heating on the cooking appliance can include, for example, four, six, or more depending upon the intended application and preferences of the buyer. These heating elements can vary in size, location, and capability across the appliance.

Recipes or prepared instructions for cooking a specific food item in the comfort of a user's home have been a long-standing staple of all types of cooking. Although some individuals are able to cook without the aid of any prepared list of steps, many individuals require a specific set of instructions in order to cook or prepare a desired food item. These recipes may be provided in books, cards, and increasingly, on an electronic user device. A website or software application (i.e., “app”) may present a recipe as a in recorded video form, which may make it easier for a user to learn certain steps or techniques.

Unfortunately, existing systems can provide an unsatisfactory user experience and can inhibit a user's desired interactions with a cooking appliance. Recipe books are often cumbersome and difficult to use while cooking. Pages may rip, stain, burn, or become otherwise damaged during use. Moreover, using only a recipe can be difficult, as it lacks the personal, tailored instruction that can come with live instruction. Similar problems may exist with recorded video.

Electronic user devices that are connected to the Internet, such as a computer, tablet or smartphone, may allow for more immediate video or audio communication with remote information servers or individuals. In turn, a remote video call or demonstration may be provided. Problems exist with this approach, though. For instance, it can be very difficult for an instructor or demonstrator to know when a user or student is falling behind or no longer following guided instruction. An instructor is generally unable to continuously see what stage or step of a recipe a user is on (and vice versa). This problem can be magnified if one instructor seeks to guide several users at once since all of the users may follow at a different pace.

As a result, improved systems are needed for facilitating instructional demonstrations to one or more remote users. In particular, it would be advantageous to provide a system or method for remotely providing an instructional demonstration while ensuring coordination between an instructor and one or more remote users.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of directing an instructional demonstration at a remote device is provided. The method may include transmitting a recipe data packet configured to initiate a user-guided presentation of a plurality of sequenced recipe panels at the remote device. The method may further include transmitting a video signal configured to initiate a real-time video feed at the remote device in tandem with the user-guided presentation and receiving a user-progress signal from the remote device. The user-progress signal may correspond to a currently-displayed recipe panel of the plurality of sequenced recipe panels at the remote device. The method may still further include presenting a panel marker at an instructor device spaced apart from the remote device. The panel marker may indicate the currently-displayed recipe panel at the remote device.

In another exemplary aspect of the present disclosure, a method of directing an instructional demonstration at a first remote device and a second remote device is provided. The method may include transmitting a recipe data packet configured to initiate a user-guided presentation of a plurality of sequenced recipe panels at the first remote device and the second remote device. The method may further include transmitting a video signal configured to initiate a real-time video feed at the first remote device and the second remote device in tandem with the user-guided presentation, receiving a first user-progress signal from the first remote device, and receiving a second user-progress signal from the second remote device. The first user-progress signal may correspond to a currently-displayed recipe panel of the plurality of sequenced recipe panels at the first remote device. The second user-progress signal may correspond to a currently-displayed recipe panel of the plurality of sequenced recipe panels at the second remote device. The method may still further include presenting a first panel marker and a second panel marker at an instructor device spaced apart from the first remote device and the second remote device. The first panel marker may indicate the currently-displayed recipe panel at the first remote device. The second panel marker may indicate the currently-displayed recipe panel at the second remote device. The method may yet further include transmitting an instructor-progress signal configured to initiate presentation of an instructor progress marker at the first remote device and the second remote device.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a remote system according to exemplary embodiments of the present disclosure.

FIG. 2 provides a side schematic view of the exemplary remote system of FIG. 1.

FIG. 3 provides a bottom perspective view of a portion of the exemplary remote system of FIG. 1.

FIG. 4 provides a schematic view of a system for instructional demonstrations according to exemplary embodiments of the present disclosure.

FIG. 5 provides a schematic view of a system for instructional demonstrations according to exemplary embodiments of the present disclosure.

FIG. 6 provides a flow chart illustrating a method of operating a system according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

Generally, the present disclosure provides methods and systems for providing instruction or guidance of, for instance, a selected recipe to one or more users (i.e., students) that are remote (i.e., in a different room, building, or city) or otherwise spaced apart from an instructor. Advantageously, the present disclosure coordinates the instructor's actions with the users' actions.

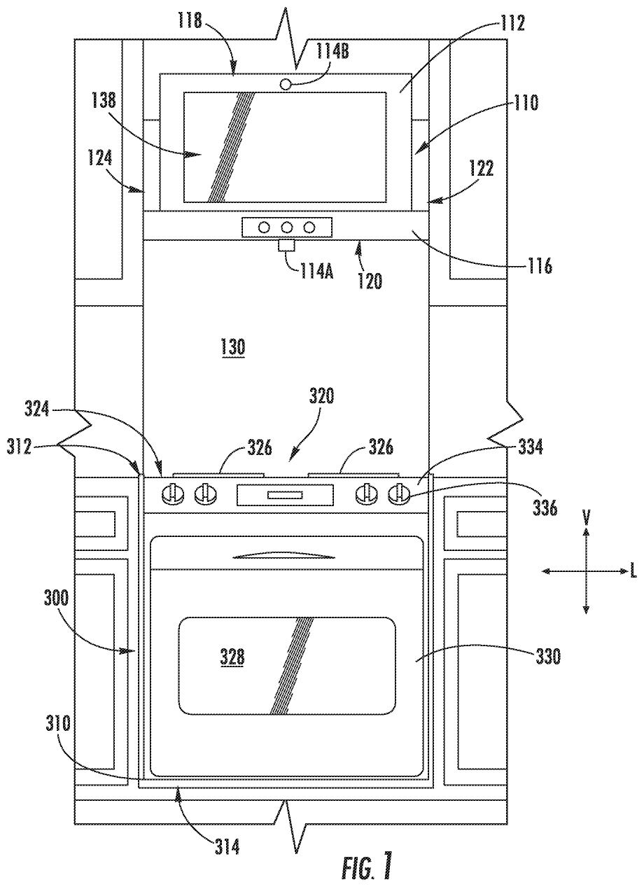

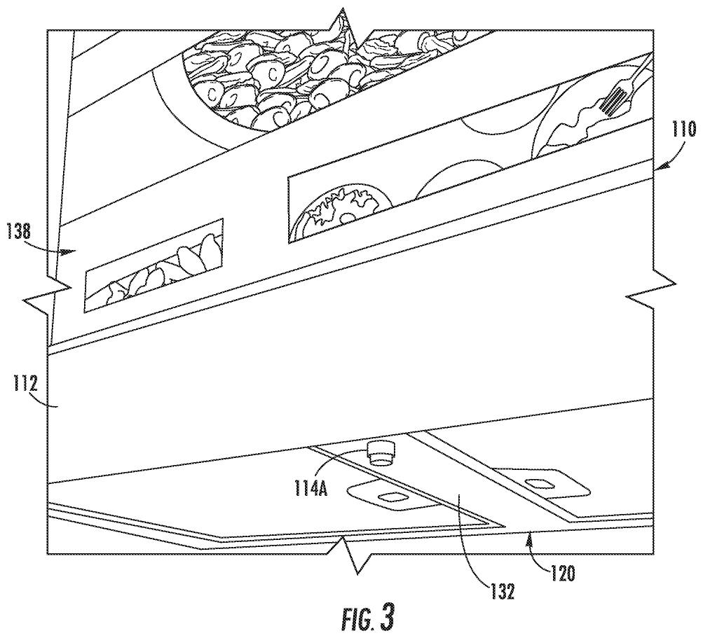

Turning to the figures, FIGS. 1 through 5 provide various views of a system 100 (or portions thereof) according to exemplary embodiments of the present disclosure. System 100 generally includes an instructor device 210 and one or more remote devices 102, which may include, for instance, a stationary interactive engagement assembly 110, mobile user devices 408, or user cooking appliance 300 with which a user may interact or engage. A remote user may thus use or interact with the remote device 102 while an instructor uses or interacts with the instructor device 210.

In some embodiments, user cooking appliance 300 is provided as or for a user with a remote device 102. As shown, cooking appliance 300 defines a vertical direction V, a lateral direction L, and a transverse direction T, for example, at a cabinet 310. The vertical, lateral, and transverse directions are mutually perpendicular and form an orthogonal direction system. As shown, cooking appliance 300 extends along the vertical direction V between a top portion 312 and a bottom portion 314; along the lateral direction L between a left side portion and a right side portion; and along the traverse direction T between a front portion and a rear portion.

Cooking appliance 300 can include a chassis or cabinet 310 that defines a cooking zone 320 wherein one or more cooking operations may be performed by a user (e.g., heating or preparing food items according to a recipe or an instructional demonstration). For example, the cooking zone 320 may be defined by a cooktop surface 324 of the cabinet 310. As illustrated, cooktop surface 324 includes one or more heating elements 326 for use in, for example, heating or cooking operations. In exemplary embodiments, cooktop surface 324 is constructed with ceramic glass. In other embodiments, however, cooktop surface 324 may include another suitable material, such as a metallic material (e.g., steel) or another suitable non-metallic material. Heating elements 326 may be various sizes and may employ any suitable method for heating or cooking an object, such as a cooking utensil 322, and its contents. In one embodiment, for example, heating element 326 uses a heat transfer method, such as electric coils or gas burners, to heat the cooking utensil 322. In another embodiment, however, heating element 326 uses an induction heating method to heat the cooking utensil 322 directly. In turn, heating element 326 may include a gas burner element, resistive heat element, radiant heat element, induction element, or another suitable heating element.

In some embodiments, cooking appliance 300 includes an insulated cabinet 310 that defines a cooking chamber 328 selectively covered by a door 330. One or more heating elements 332 (e.g., top broiling elements or bottom baking elements) may be enclosed within cabinet 310 to heat cooking chamber 328. Heating elements 332 within cooking chamber 328 may be provided as any suitable element for cooking the contents of cooking chamber 328, such as an electric resistive heating element, a gas burner, microwave element, halogen element, etc. Thus, cooking appliance 300 may be referred to as an oven range appliance. As will be understood by those skilled in the art, cooking appliance 300 is provided by way of example only, and the present subject matter may be used in any suitable cooking appliance 300, such as a double oven range appliance, standalone oven, or a standalone cooktop (e.g., fitted integrally with a surface of a kitchen counter). Thus, the exemplary embodiments illustrated in figures are not intended to limit the present subject matter to any particular cooking chamber or heating element configuration, except as otherwise indicated.

As illustrated, a user interface or user interface panel 334 may be provided on cooking appliance 300. Although shown at the front portion of cooking appliance 300, another suitable location or structure (e.g., a backsplash) for supporting user interface panel 334 may be provided in alternative embodiments. In some embodiments, user interface panel 334 includes input components or controls 336, such as one or more of a variety of electrical, mechanical, or electro-mechanical input devices. Controls 336 may include, for example, rotary dials, knobs, push buttons, and touch pads. A controller 510C is in communication with user interface panel 334 and controls 336 through which a user may select various operational features and modes and monitor progress of cooking appliance 300. In additional or alternative embodiments, user interface panel 334 includes a display component, such as a digital display in communication with a controller 510C and configured to provide operational feedback to a user. In certain embodiments, user interface panel 334 represents a general purpose I/O (“GPIO”) device or functional block.

As shown, controller 510C is communicatively coupled (i.e., in operative communication) with user interface panel 334 and its controls 336. Controller 510C may also be communicatively coupled with various operational components of cooking appliance 300 as well, such as heating elements (e.g., 326, 332), sensors, etc. Input/output (“I/O”) signals may be routed between controller 510C and the various operational components of cooking appliance 300. Thus, controller 510C can selectively activate and operate these various components. Various components of cooking appliance 300 are communicatively coupled with controller 510C via one or more communication lines such as, for example, conductive signal lines, shared communication busses, or wireless communications bands.

In some embodiments, controller 510C includes one or more memory devices 514C and one or more processors 512C. The processors 512C can be any combination of general or special purpose processors, CPUs, or the like that can execute programming instructions or control code associated with operation of cooking appliance 300. The memory devices 514C (i.e., memory) may represent random access memory such as DRAM or read only memory such as ROM or FLASH. In one embodiment, the processor 512C executes programming instructions stored in memory 514C. The memory 514C may be a separate component from the processor 512C or may be included onboard within the processor 512C. Alternatively, controller 510C may be constructed without using a processor, for example, using a combination of discrete analog or digital logic circuitry (such as switches, amplifiers, integrators, comparators, flip-flops, AND gates, and the like) to perform control functionality instead of relying upon software.

In certain embodiments, controller 510C includes a network interface 520C such that controller 510C can connect to and communicate over one or more networks (e.g., network 502) with one or more network nodes. Controller 510C can also include one or more transmitting, receiving, or transceiving components for transmitting/receiving communications with other devices communicatively coupled with cooking appliance 300. Additionally or alternatively, one or more transmitting, receiving, or transceiving components can be located off board controller 510C. Generally, controller 510C can be positioned in any suitable location throughout cooking appliance 300. For example, controller 510C may be located proximate user interface panel 334 toward the front portion of cooking appliance 300.

As shown, an interactive assembly 110 having one or more casings (e.g., hood casing 116) may be provided above cooking appliance 300 along the vertical direction V. For example, a hood casing 116 may be positioned above cooking appliance 300 in a stationary mounting (e.g., such that operation of interactive assembly 110 is not permitted unless casing 116 is mounted at a generally fixed or non-moving location). Hood casing 116 includes a plurality of outer walls and generally extends along the vertical direction V between a top end 118 and a bottom end 120; along the lateral direction L between a first side end 122 and a second side end 124; and along the transverse direction T between a front end 126 and a rear end 128. In some embodiments, hood casing 116 is spaced apart from cooking zone 320 or cooktop surface 324 along the vertical direction V. An open region 130 may thus be defined along the vertical direction V between cooking zone 320 or cooktop surface 324 and bottom end 120.

In optional embodiments, hood casing 116 is formed as a range hood. A ventilation assembly within hood casing 116 may thus direct an airflow from the open region 130 and through hood casing 116. However, a range hood is provided by way of example only. Other configurations may be used within the spirit and scope of the present disclosure. For example, hood casing 116 could be part of a microwave or other appliance designed to be located above cooking appliance 300 (e.g., directly above cooktop surface 324). Moreover, although a generally rectangular shape is illustrated, any suitable shape or style may be adapted to form the structure of hood casing 116.

In certain embodiments, one or more camera assemblies 114A, 114B are provided (e.g., as part of interactive assembly 110) to capture images (e.g., static images or dynamic video) of a portion of cooking appliance 300 or an area adjacent to cooking appliance 300. Generally, each camera assembly 114A, 114B may be any type of device suitable for capturing a picture or video. As an example, each camera assembly 114A, 114B may be a video camera or a digital camera with an electronic image sensor [e.g., a charge coupled device (CCD) or a CMOS sensor]. A camera assembly 114A or 114B is generally provided in operable communication with controller 510A such that controller 510A may receive an image signal (e.g., video signal) from camera assembly 114A or 114B corresponding to the picture(s) captured by camera assembly 114A or 114B. Once received by controller 510A, the image signal (e.g., video signal) may be further processed at controller 510A (e.g., for viewing at an image monitor 112) or transmitted to a separate device (e.g., remote server 404) “live” or in real-time for remote viewing (e.g., at instructor device 210). Optionally, one or more microphones (not pictured) may be associated with one or more of the camera assemblies 114A, 114B to capture and transmit audio signal(s) coinciding (or otherwise corresponding) with the captured image signal or picture(s).

In some embodiments, one camera assembly (e.g., first camera assembly 114A) is directed at cooking zone 320 (e.g., cooktop surface 324). In other words, first camera assembly 114A is oriented to capture light emitted or reflected from cooking zone 320 through the open region 130. In some such embodiments, first camera assembly 114A can selectively capture an image covering all or some of cooktop surface 324. For instance, first camera assembly 114A may capture an image covering one or more heating elements 326 of cooking appliance 300. In some such embodiments, the captured heating elements 326 and any utensil 322 placed on one of the heating elements 326 (or otherwise between cooking zone 320 and first camera assembly 114A) may be recorded and transmitted instantly to another portion of system (e.g., image monitor 112) as part of a real-time video feed. Thus, the real-time video feed may include a digital picture or representation 142 of the heating elements 326 or utensil 322. Optionally, first camera assembly 114A may be directed such that a line of sight is defined from first camera assembly 114A that is perpendicular to cooktop surface 324.

As shown, first camera assembly 114A is positioned above cooking zone 320 (e.g., along the vertical direction V). In some such embodiments, first camera assembly 114A is mounted (e.g., fixedly or removably) to hood casing 116. A cross-brace 132 extending across hood casing 116 (e.g., along the transverse direction T) may support first camera assembly 114A. When assembled, first camera assembly 114A may be positioned directly above cooking zone 320 or cooktop surface 324.

In additional or alternative embodiments, one camera assembly (e.g., second camera assembly 114B) is directed away from cooking zone 320 or cooktop surface 324. In other words, second camera assembly 114B is oriented to capture light emitted or reflected from an area other than cooktop surface 324. In particular, second camera assembly 114B may be directed at the area in front of cooking appliance 300 (e.g., directly forward from cooking appliance 300 along the transverse direction T). Thus, second camera assembly 114B may selectively capture an image of the area in front of cooking zone 320. This area may correspond to or cover the location where a user would typically stand during use of cooking appliance 300. During use, a user's face or body may be captured by second camera assembly 114B while the user is standing directly in front of cooking appliance 300. Optionally, second camera assembly 114B may be directed such that a line of sight is defined from second camera assembly 114B that is non-orthogonal to cooktop surface 324 (e.g., between 0° and 45° relative to a plane parallel to cooktop surface 324). The captured images from second camera assembly 114B may be suitable for transmission to a remote device 102 or may be processed as part of one or more operations of interactive assembly 110, such as a gesture control signal for a portion of interactive assembly 110 (e.g., to engage a graphical user interface displayed at image monitor 112).

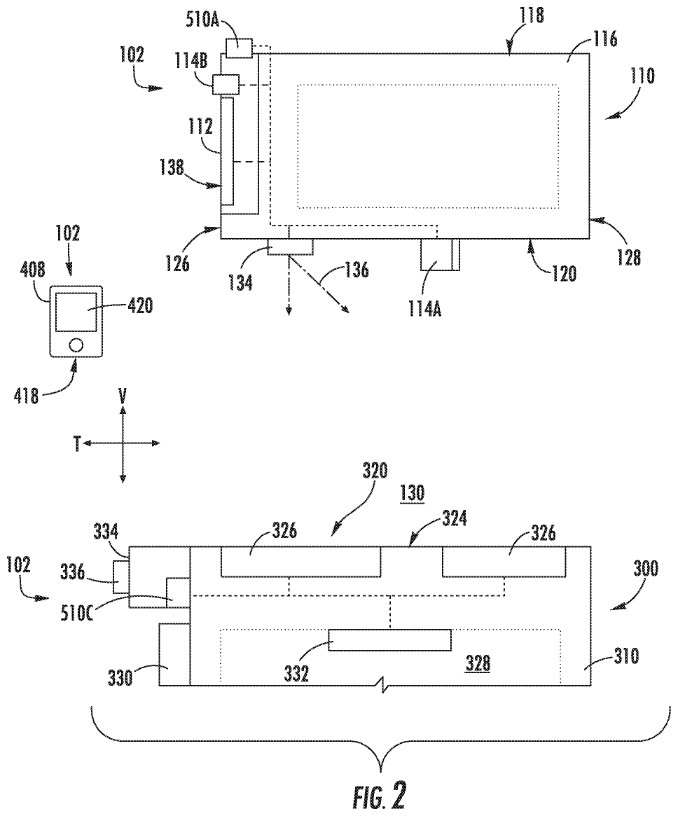

As shown, second camera assembly 114B is positioned above cooking appliance 300 (e.g., along the vertical direction V). In some such embodiments, such as that illustrated in FIGS. 1 and 2, second camera assembly 114B is mounted (e.g., fixedly or removably) to a front portion of hood casing 116 (e.g., at image monitor 112). When assembled, second camera assembly 114B may be positioned directly above a portion of cooking appliance 300 (e.g., cooking zone 320 or cooktop surface 324) or, additionally, forward from cooking appliance 300 along the transverse direction T.

In optional embodiments, a lighting assembly 134 is provided above cooktop surface 324 (e.g., along the vertical direction V). For instance, lighting assembly 134 may be mounted to hood casing 116 (e.g., directly above cooking zone 320 or cooktop surface 324). Generally, lighting assembly 134 includes one or more selectable light sources directed toward cooking zone 320. In other words, lighting assembly 134 is oriented to project a light (as indicated at arrows 136) to cooking appliance 300 through open region 130 and illuminate at least a portion of cooking zone 320 (e.g., cooktop surface 324). The light sources may include any suitable light-emitting elements, such as one or more light emitting diode (LED), incandescent bulb, fluorescent bulb, halogen bulb, etc.

In some embodiments, image monitor 112 is provided as part of interactive assembly 110 above cooking zone 320 (e.g., along the vertical direction V). For instance, image monitor 112 may be mounted to hood casing 116 (e.g., directly above cooking appliance 300, cooking zone 320, or cooktop surface 324). Generally, image monitor 112 may be any suitable type of mechanism for visually presenting a digital image. For example, image monitor 112 may be a liquid crystal display (LCD), a plasma display panel (PDP), a cathode ray tube (CRT) display, etc. Thus, image monitor 112 includes an imaging surface 138 (e.g., screen or display panel) at which the digital image is presented or displayed as an optically-viewable picture (e.g., static image, dynamic or moving video, etc.) to a user. The optically-viewable picture may correspond to any suitable signal or data received or stored by interactive assembly 110 (e.g., at controller 510A). As an example, image monitor 112 may present one or more recipe panels 220 (e.g., predefined regions of preset legible text, static images, or dynamic recorded video relating to an instructional demonstration). As another example, image monitor 112 may present a remotely captured image, such as a live (e.g., real-time) dynamic video feed 222 that is received from a separate device (e.g., instructor device 210). As yet another example, image monitor 112 may present a graphical user interface (GUI) that allows a user to select or manipulate various operational features of interactive assembly 110 or cooking appliance 300. During use of such GUI embodiments, a user may engage, select, or adjust the image presented at image monitor 112 through any suitable input, such as gesture controls detected through second camera assembly 114B, voice controls detected through one or more microphones, associated touch panels (e.g., capacitance or resistance touch panel) or sensors overlaid across imaging surface 138, etc. For instance, a user may manually select or change the recipe panel 220 being presented at image monitor 112. Additionally or alternatively, a user may select from a plurality of options what information or data to share with other components (e.g., instructor device 210). Such a selection may be made as a communication-approval input prompting transmission of a communication-approval signal granting a two-way signal exchange between the interactive assembly 110 and another device (e.g., instructor device 210).

As illustrated, the imaging surface 138 generally faces, or is directed, away from cooking appliance 300 (e.g., away from cooking zone 320 or cabinet 310). In particular, the imaging surface 138 is directed toward the area forward from the cooking appliance 300. During use, a user standing in front of cooking appliance 300 may thus see the optically-viewable picture (e.g., recipe panel 220, video feed 222, instructor-progress markers 226, graphical user interface, etc.) displayed at the imaging surface 138. Optionally, the imaging surface 138 may be positioned at a rearward non-orthogonal angle relative to the vertical direction V. In other words, the imaging surface 138 may be inclined such that an upper edge of the imaging surface 138 is closer to the rear end 128 of hood casing 116 than a lower edge of the imaging surface 138 is. In some such embodiments, the non-orthogonal angle is between 1° and 15° relative to the vertical direction V. In certain embodiments, the non-orthogonal angle is between 2° and 7° relative to the vertical direction V.

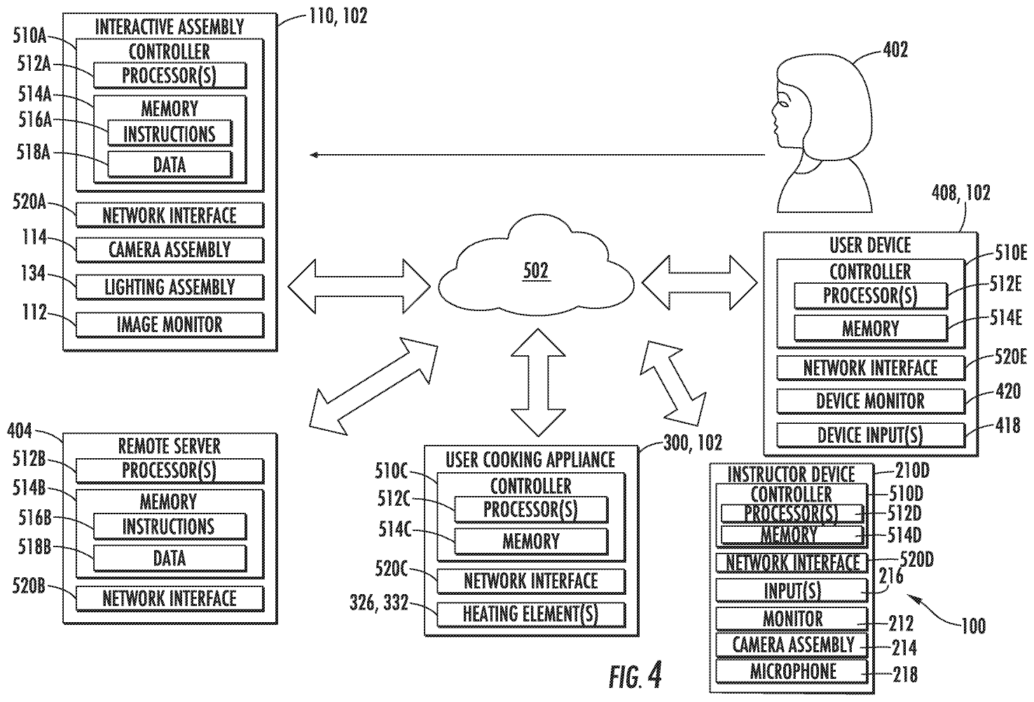

FIG. 4 provides a schematic view of a system 100 for instructional demonstrations according to exemplary embodiments of the present disclosure. As shown, various components can be communicatively coupled with network 502 and various other nodes, such as instructor device 210 and one or more remote devices 102 (e.g., interactive assembly 110, cooking appliance 300, and one or more mobile user devices 408). Moreover, one or more users 402 can be in operative communication with at least one remote device 102 (e.g., interactive assembly 110) by various methods, including voice control or gesture recognition, for example. Additionally, or alternatively, although network 502 is shown, one or more portions of the system (e.g., interactive assembly 110, cooking appliance 300, mobile user devices 408, instructor device 210, or other devices within system) may be communicatively coupled without network 502; rather, interactive assembly 110 and various other devices of the system can be communicatively coupled via any suitable wired or wireless means not over network 502, such as, for example, via physical wires, transceiving, transmitting, or receiving components.

As noted above, interactive assembly 110 may include a controller 510A communicatively coupled to one or more camera assemblies 114, lighting assemblies 134, and image monitors 110. Controller 510A may include one or more processors 512A and one or more memory devices 514A (i.e., memory). The one or more processors 512A can be any suitable processing device (e.g., a processor core, a microprocessor, an ASIC, a FPGA, a microcontroller, etc.) and can be one processor or a plurality of processors that are operatively connected. The memory device 514DA can include one or more non-transitory computer-readable storage mediums, such as RAM, ROM, EEPROM, EPROM, flash memory device, magnetic disks, etc., and combinations thereof. The memory devices 514A can store data 518A and instructions 516A that are executed by the processor 512A to cause interactive assembly 110 to perform operations. For example, instructions 516A could be instructions for voice recognition, instructions for gesture recognition, receiving/transmitting images or image signals from a camera assembly 114, directing activation of lighting assembly 134, or projecting images at image monitor 112. The memory devices 514A may also include data 518A, such as one or more received user-guided presentations (e.g., including a plurality of sequenced recipe panels), video signals, instructor panels, etc., that can be retrieved, manipulated, created, or stored by processor 512A.

Controller 510A includes a network interface 520A such that interactive assembly 110 can connect to and communicate over one or more networks (e.g., network 502) with one or more network nodes. Network interface 520A can be an onboard component of controller 510A or it can be a separate, off board component. Controller 510A can also include one or more transmitting, receiving, or transceiving components for transmitting/receiving communications with other devices communicatively coupled with interactive assembly 110. Additionally or alternatively, one or more transmitting, receiving, or transceiving components can be located off board controller 510A.

Network 502 can be any suitable type of network, such as a local area network (e.g., intranet), wide area network (e.g., internet), low power wireless networks [e.g., Bluetooth Low Energy (BLE)], or some combination thereof and can include any number of wired or wireless links. In general, communication over network 502 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

In some embodiments, a remote server 404, such as a web server, is in operable communication with one or more instructor devices 210 or remote devices 102 (e.g., interactive assembly 110, cooking appliance 300, or mobile user devices 408). The server 404 can be used to host an engagement platform [e.g., for sharing or facilitating instructional demonstrations (such as cooking demonstrations), recipes, etc.]. Additionally or alternatively, the server 404 can be used to host an information database (e.g., for storing recipes including a plurality of sequenced recipe panels). The server 404 can be implemented using any suitable computing device(s). The server 404 may include one or more processors 512B and one or more memory devices 514B (i.e., memory). The one or more processors 512B can be any suitable processing device (e.g., a processor core, a microprocessor, an ASIC, a FPGA, a microcontroller, etc.) and can be one processor or a plurality of processors that are operatively connected. The memory device 512B can include one or more non-transitory computer-readable storage mediums, such as RAM, ROM, EEPROM, EPROM, flash memory devices, magnetic disks, etc., and combinations thereof. The memory devices 514B can store data 518B and instructions 516B which are executed by the processor 512B to cause remote server 404 to perform operations. For example, instructions 516B could be instructions for receiving/transmitting recipe data packets, transmitting/receiving video signals, transmitting/receiving progress signals (e.g., user-progress or instructor-progress signals), etc.

The memory devices 514B may also include data 518B, such as recipe data packets (e.g., which may be configured to initiate a user-guided presentation of a plurality of sequenced recipe panels at a separate remote device 102), identifier data (e.g., corresponding to a particular user, instructor, or remote device 102), etc., that can be retrieved, manipulated, created, or stored by processor 512B. The data 518B can be stored in one or more databases. The one or more databases can be connected to remote server 404 by a high bandwidth LAN or WAN, or can also be connected to remote server 404 through network 502. The one or more databases can be split up so that they are located in multiple locales.

Remote server 404 includes a network interface 520B such that interactive remote server 404 can connect to and communicate over one or more networks (e.g., network 502) with one or more network nodes. Network interface 520B can be an onboard component or it can be a separate, off board component. In turn, remote server 404 can exchange data with one or more nodes over the network 502. As an example, remote server 404 can exchange data with one or more remote devices 102 (e.g., interactive assembly 110, cooking appliance 300, or mobile user devices 408). As another example, remote server 404 can exchange data with one or more instructor devices 210. Generally, it is understood that remote server 404 may further exchange data with any number of client devices over the network 502. The client devices can be any suitable type of computing device, such as a general-purpose computer, special purpose computer, laptop, desktop, integrated circuit, mobile device, smartphone, tablet, or other suitable computing device. In some embodiments, data including images (e.g., static images or dynamic video), audio, or text may thus be exchanged between interactive assembly 110 and various separate client devices through remote server 404.

In some embodiments, an instructor device 210 is in operable communication with one or more remote devices 102 (e.g., interactive assembly 110, cooking appliance 300, or mobile user devices 408) via network 502. Optionally, instructor device 210 is in operable communication with and can communicate directly with one or more remote devices 102 via network 502. Alternatively, instructor device 210 is in operable communication with and can communicate indirectly with one or more remote devices 102 by communicating via network 502 with remote server 404, which in turn communicates with remote device(s) 102 via network 502.

Generally, instructor device 210 can be any suitable type of device for interacting with one or more remote users, such as a personal computing device (e.g., laptop or desktop), a mobile computing device (e.g., smartphone or tablet), or interactive assembly (e.g., including all or some of the components of interactive assembly 110, described above). Instructor device 210 includes a controller 510D. Controller 510D may include one or more processors 512D and one or more memory devices 514D (i.e., memory). The one or more processors 512D can be any suitable processing device (e.g., a processor core, a microprocessor, an ASIC, a FPGA, a microcontroller, etc.) and can be one processor or a plurality of processors that are operatively connected. The memory device 514D can include one or more non-transitory computer-readable storage mediums, such as RAM, ROM, EEPROM, EPROM, flash memory device, magnetic disks, etc., and combinations thereof. The memory devices 514D can store data and instructions that are executed by the processor 512D to cause instructor device 210 to perform operations. For example, instructions could be instructions for receiving/transmitting image or video signals from a camera assembly 214, receiving/transmitting audio signals from a microphone 216, or projecting images at an instructor monitor 212. The memory devices 514D may also include data, such as one or more stored user-guided presentations (e.g., including a plurality of sequenced recipe panels), video signals, instructor panels, etc., that can be retrieved, manipulated, created, or stored by processor 512D.

Instructor device 210 can include one or more instructor inputs 216 (e.g., buttons, knobs, one or more cameras, etc.) or an instructor monitor 212 configured to display graphical user interfaces or other visual representations to an instructor. For example, instructor monitor 212 can display graphical user interfaces corresponding to one or more remote devices 102 such that an instructor may see a visual representation of what step or point in a recipe that a user has reached. Instructor monitor 212 can be a touch sensitive component (e.g., a touch-sensitive display screen or a touch pad) that is sensitive to the touch of a user input object (e.g., a finger or a stylus). For example, an instructor may touch the instructor monitor 212 with his or her finger and make a selection from a GUI. In addition, motion of the user input object relative to the instructor monitor 212 can enable the instructor to provide input to instructor device 210. Instructor device 210 may provide other suitable methods for providing input to instructor device 210 as well. Moreover, instructor device 210 can include one or more speakers, one or more cameras, or more than one microphones such that use instructor device 210 is configured with voice control, motion detection, and other functionality.

In some embodiments, instructor device 210 includes an instructor camera assembly 214 to capture images (e.g., dynamic video) of a portion of instructor device 210 or an area adjacent to instructor device 210. Generally, instructor camera assembly 214 may be any type of device suitable for capturing a picture or video. As an example, instructor camera assembly 214 may be a video camera or a digital camera with an electronic image sensor [e.g., a charge coupled device (CCD) or a CMOS sensor]. Instructor camera assembly 214 is generally provided in operable communication with controller 510D such that controller 510D may receive an image signal (e.g., video signal) from instructor camera assembly 214 corresponding to the picture(s) captured by camera assembly 214. Once received by controller 510D, the image signal (e.g., video signal) may be further processed at controller 510D (e.g., for viewing at instructor monitor 212) or transmitted to a separate device (e.g., remote server 404) “live” or in real-time for remote viewing (e.g., at a remote device 102, such as interactive assembly 110). Optionally, one or more microphones 218 may be associated with instructor camera assembly 214 to capture and transmit audio signal(s) coinciding (or otherwise corresponding) with the captured image signal or video.

Controller 510D includes a network interface 520D such that instructor device 210 can connect to and communicate over one or more networks (e.g., network 502) with one or more network nodes. Network interface 520D can be an onboard component of controller 510D or it can be a separate, off board component. Controller 510D can also include one or more transmitting, receiving, or transceiving components for transmitting/receiving communications with other devices communicatively coupled with instructor device 210. Additionally or alternatively, one or more transmitting, receiving, or transceiving components can be located off board controller 510D.

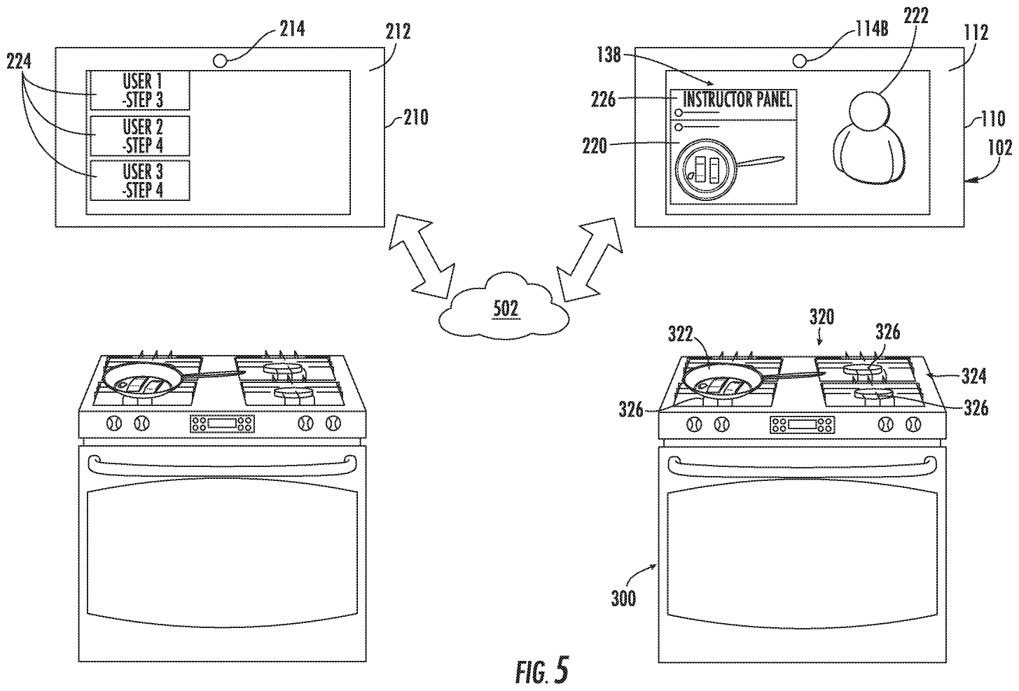

Turning especially to FIG. 5, in exemplary embodiments, instructor device 210 can communicate with (e.g., transmit/receive signals to/from) a remote device 102, such as interactive assembly 110. For example, instructor device 210 can transmit/receive signals as part a remote cooking class taught by an instructor in one location (e.g., building, city, area, etc.) and followed by users in another, spaced-apart location (e.g., another building, city, area, etc.). Prior to the class beginning, a recipe can be provided to the remote device 102 (e.g., interactive assembly 110) so that a user can follow along as the instructor performs the same recipe. The recipe may be provided as a recipe data packet that includes multiple discrete recipe panels arranged in a set sequence or order (e.g., first to last). Once received by the remote device 102, a user may advance/regress through the recipe panels 220 at his/her own pace and according to the sequence. Each recipe panel 220 may include preset legible text, static images, or dynamic video (e.g., prerecorded video) relating to a specific step of the recipe that the user should perform. The remote device 102 may display at least one of the recipe panels 220 at a time. This currently-displayed recipe panel 220 may generally indicate the user's progress or point in the recipe.

As the recipe (e.g., recipe panel 220) is being presented or displayed at the remote device 102, the instructor device 210 may also transmit a video signal (e.g., from instructor camera assembly 214) that can be received by the remote device 102. Once received by the remote device 102, the video signal may initiate a real-time or “live” video feed 222 so that the instructor's physical actions can be seen by the user. The real-time video feed 222 may be displayed in tandem with the recipe panel 220. Advantageously, the user may readily view both the recipe and the instructor as the user follows along.

As the recipe (e.g., recipe panel 220) is being presented or displayed at the remote device 102, the remote device 102 may also transmit a corresponding signal that can be received by the instructor device 210. Specifically, a user-progress signal may be received that corresponds to which recipe panel 220 is being displayed at the remote device 102. In response to receiving the user-progress signal, the instructor device 210 may present or display a panel marker 224 indicating which recipe panel 220 is being displayed at the remote device 102. If multiple users are following the class, multiple user-progress signals may be received, and multiple panel markers 224 may be presented.

In optional embodiments, the instructor can also provide an indication of what panel (e.g., recipe panel) or point of a recipe he or she is currently demonstrating. For example, the instructor device 210 may transmit an instructor-progress signal to the remote device 102. At the remote device 102, the instructor-progress signal may cause an instructor-progress marker 226 to be presented or displayed.

It is noted that in some embodiments, such as those illustrated at FIG. 5, interactive assembly 110 is provided as a remote device 102 (e.g., for communication with remote server 404 to receive one or more recipe data packets, which may be configured to initiate a user-guided presentation of a plurality of sequenced recipe panels). Nonetheless, in additional or alternative embodiments, another device, such as a mobile user device 408 or cooking appliance 300, are provided as a remote device 102 (e.g., for communication with remote server 404 to receive one or more recipe data packets, which may be configured to initiate a user-guided presentation of a plurality of sequenced recipe panels). Moreover, although FIG. 4 illustrates a single interactive assembly 110, further embodiments may include any number of remote devices 102 (e.g., multiple discrete interactive assemblies, mobile user devices, or cooking appliances) in operable communication (e.g., with a common instructor device 210) via network 502.

Returning especially to FIG. 4, in optional embodiments, cooking appliance 300 is in operable communication with instructor device 210 via network 502 (e.g., wherein cooking appliance 300 is provided as a remote device 102). Optionally, cooking appliance 300 is in operable communication with and can communicate directly with instructor device 210 via network 502. Alternatively, cooking appliance 300 is in operable communication with and can communicate indirectly with instructor device 210 by communicating via network 502 with remote server 404, which in turn communicates with instructor device 210 via network 502. In turn, controller 510C of cooking appliance 300 may exchange signals with instructor device 210. In some embodiments, one or more portions of cooking appliance 300 can be controlled according to signals received from controller 510D of instructor device 210. For instance, a monitor of cooking appliance 300 may project or display recipe panels of a user-guided presentation as well as a real-time video feed 222 based on one or more signals received from controller 510D of instructor device 210 or remote server 404 (e.g., similar to what is described above with respect to interactive assembly 110).

In certain embodiments, a user device 408 is communicatively coupled with network 502 such that user devices 408 can communicate with instructor device 210. User devices 408 can communicate directly with instructor device 210 via network 502. Alternatively, user devices 408 can communicate indirectly with instructor device 210 by communicating via network 502 with remote server 404, which in turn communicates with instructor device 210 via network 502. Moreover, user 402 can be in operative communication with user devices 408 such that user 402 can communicate with instructor device 210 via user devices 408.

User device 408 can be any type of device, such as, for example, a personal computing device (e.g., laptop or desktop), a mobile computing device (e.g., smartphone or tablet), a gaming console or controller, a wearable computing device, an embedded computing device, a remote, or any other suitable type of user computing device. User device 408 can include one or more user device controllers 510E. Controller 510E can include one or more processors 512E and one or more memory devices 514E. The one or more processors 512E can be any suitable processing device (e.g., a processor core, a microprocessor, an ASIC, a FPGA, a controller, a microcontroller, etc.) and can be one processor or a plurality of processors that are operatively connected. The memory device (i.e., memory) can include one or more non-transitory computer-readable storage mediums, such as RAM, ROM, EEPROM, EPROM, flash memory devices, magnetic disks, etc., and combinations thereof. The memory can store data and instructions which are executed by the processor 512E to cause user device 408 to perform operations. Controller 510E may include a user device network interface 520E such that user device 408 can connect to and communicate over one or more networks (e.g., network 502) with one or more network nodes. Network interface 520E can be an onboard component of controller 510E or it can be a separate, off board component. Controller 510E can also include one or more transmitting, receiving, or transceiving components for transmitting/receiving communications with other devices communicatively coupled with user device 408. Additionally or alternatively, one or more transmitting, receiving, or transceiving components can be located off board controller 510E.

User device 408 can include one or more user inputs 418 (e.g., buttons, knobs, one or more cameras, etc.) or a monitor 420 configured to display graphical user interfaces or other visual representations to user. For example, monitor 420 can display graphical user interfaces corresponding to operational features of interactive assembly 110 such that user may manipulate or select the features to operate interactive assembly 110. Monitor 420 can be a touch sensitive component (e.g., a touch-sensitive display screen or a touch pad) that is sensitive to the touch of a user input object (e.g., a finger or a stylus). For example, a user 402 may touch the monitor 420 with his or her finger and type in a series of numbers on the monitor 420. In addition, motion of the user input object relative to the monitor 420 can enable user 402 to provide input to user device 408. User device 408 may provide other suitable methods for providing input to user device 408 as well. Moreover, user device 408 can include one or more speakers, one or more cameras, or more than one microphones such that user device 408 is configured with voice control, motion detection, and other functionality.

As noted above, user device 408 may communicate with instructor device (e.g., directly or indirectly). In turn, controller 510E of user device 408 may exchange signals with instructor device 210. In some embodiments, one or more portions of user device 408 can be controlled according to signals received from controller 510D of instructor device 210. For instance, the monitor 420 may project or display recipe panels of a user-guided presentation as well as a real-time video feed 222 based on one or more signals received from controller 510D of instructor device 210 or remote server 404 (e.g., similar to what is described above with respect to interactive assembly 110).

Generally, user 402 may be in operative communication with a remote device 102 (e.g., interactive assembly 110, cooking appliance 300, or one or more user devices 408). In some exemplary embodiments, user 402 can communicate with remote device(s) 102 (e.g., interactive assembly 110) using voice control. User 402 may also be in operative communication via other methods as well, such as visual communication.

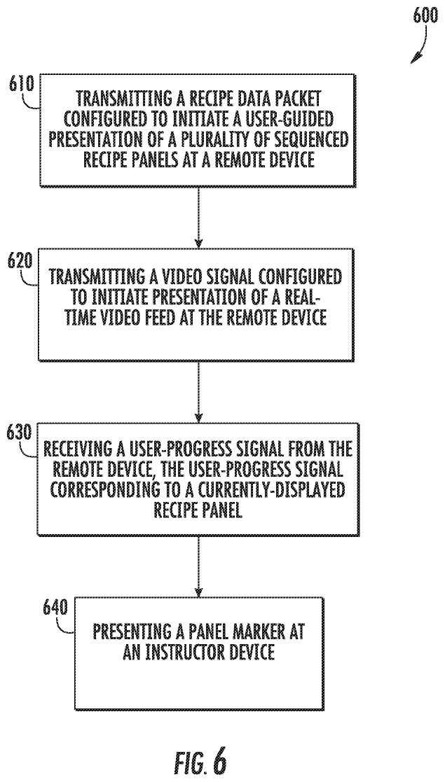

Referring now to FIG. 6, various methods may be provided for use with system 100 (FIG. 1) in accordance with the present disclosure. In general, the various steps of methods as disclosed herein may, in exemplary embodiments, be performed by the controller 510D (FIG. 4) as part of an operation that the controller 510D is configured to initiate (e.g., an instructional demonstration coordinated between multiple devices). During such methods, controller 510D may receive inputs and transmit outputs from various other components of the system 100. For example, controller 510D may send signals to and receive signals from remote server 404, interactive assembly 110, cooking appliance 300, or user devices 408, as well as components within instructor device 210. In particular, the present disclosure is further directed to methods, as indicated by 600, for operating system 100. Such methods advantageously facilitate guided or interactive cooking instruction (e.g., an instructional demonstration) between an instructor and one or more remote users. In certain embodiments, such methods may advantageously the coordinate actions by an instructor at instructor device 210 with actions with of a user at a remote device 102 (e.g., interactive assembly 110, cooking appliance 300, or user device 408), such as while a user is actively engaged with (e.g., using) cooking appliance 300.

FIG. 6 depicts steps performed in a particular order for purpose of illustration and discussion. Those of ordinary skill in the art, using the disclosures provided herein, will understand that (except as otherwise explicitly or implicitly indicated) the steps of any of the methods disclosed herein can be modified, adapted, rearranged, omitted, or expanded in various ways without deviating from the scope of the present disclosure.

As shown in FIG. 6, at 610, method 600 includes transmitting a recipe data packet for an instruction demonstration or class (e.g., a cooking class to teach a specific recipe). The recipe data packet may be configured to initiate a user-guided presentation of a plurality of sequenced recipe panels at a remote device (e.g., first remote device). Thus, the recipe data packet generally includes multiple recipe panels to be presented or displayed in a set order or sequence at the remote device. In some embodiments, the user-guided presentation provides or relates to a recipe that an instructor and remote user will each be following.

Each recipe panel may illustrate one or more unique steps or associated information for the recipe. In some embodiments, the recipe panels include user-viewable media that is preset within the recipe panel and relates to the instructional demonstration. As an example, the recipe panels may include preset legible text relating to the instructional demonstration (e.g., words describing a recipe step). As another example, the recipe panels may include one or more preset static images relating to the instructional demonstration (e.g., pictures demonstrating a recipe step or state of a food product after a recipe step). As yet another example, the recipe panels may include dynamic video (e.g., prerecorded video of a recipe step being performed). Generally, while a single recipe panel is presented or displayed (i.e., as a currently displayed recipe panel), the single recipe panel may only occupy a portion of a monitor of the remote device (e.g., image monitor in front of the cooking zone of the cooking appliance).

As described above, the remote device may be a suitable mobile user device, interactive engagement assembly, or cooking appliance.

At 620, the method 600 includes transmitting a video signal from the instructor device to the remote device (e.g., directly or, alternatively, indirectly through a remote server). As described above, the instructor device may include a camera assembly. The video signal at 620 may originate at or correspond to the camera assembly of the instructor device. As would be understood, the video signal may include multiple sequenced images captured by the camera assembly. In some embodiments, the captured video signal is transmitted in real-time (e.g., continuously or instantly). For instance, the video signal may be received by the controller of the interactive assembly or another node of the system (e.g., the remote server). A real-time dynamic video signal or stream may be transmitted based on a view or image detected at the camera assembly of the instructor device.

The video signal is configured to initiate a real-time video feed at the remote device. Thus, the real-time feed may provide live video (e.g., continuously-updating digital images) that a user may view on the remote device (e.g., image monitor in front of the cooking zone of the cooking appliance). Optionally, associated audio may be included with or accompany the video. Moreover, the real-time feed may be provided in tandem with the user-guided presentation. Thus, the real-time feed may be presented or displayed at the same time as at least one recipe panel. This may allow a user to view the recipe at the same time and on the same monitor or screen as the real-time feed.

At 630, the method 600 includes receiving a user-progress signal from the remote device (e.g., directly or, alternatively, indirectly through a remote server). The user-progress signal may correspond to a currently-displayed recipe panel of the plurality of sequenced recipe panels at the remote device. In other words, the user-progress signal may correspond to which recipe panel is currently being shown or displayed at the remote device. In some embodiments, the remote device transmits the user-progress signal whenever a panel selection is made or the panel being displayed changes (i.e., when a user manually advances/regresses the user-guided presentation). Thus, the user-progress signal may be received in response to a panel selection signal manually prompted by a user at the remote device. The user may, for example, prompt a panel selection by engaging an input of the remote device, such as a button, knob, or touchscreen, as described above.

In optional embodiments, the remote device may only be permitted to transmit a user-progress signal if approval for communications with the instructor device has been previously granted. In some such embodiments, the method 600 includes, prior to 630, receiving a communication-approval signal from the remote device. The communication-approval signal may be transmitted in response to a user selection or prompt at the remote device. The user may, for example, grant approval by engaging an input of the remote device, such as a button, knob, or touchscreen, when prompted with a request or within a preprogrammed menu of the remote device. Once transmitted and received, the communication-approval signal may grant a two-way signal exchange between the instructor device and the remote device such that the remote device will be able to not only receive a signal from the instructor device, but also to transmit a signal to the instructor device.

At 640, the method 600 includes presenting a panel marker at the instructor device. Generally, the panel marker corresponds to the user progress signal received at 630. Specifically, the panel marker may indicate the currently-displayed recipe panel at the remote device. As an example, the panel marker may display a number or character associated with the specific recipe panel. As another example, the panel marker may provide or reproduce a portion (e.g., all or a mere sub-portion) of the recipe panel being displayed at the remote device (i.e., the currently-displayed panel of the remote device). The instructor may thus be provided with an indication of what step the remote user is currently trying to understand or perform.

In optional embodiments, an instructor-progress signal may similarly be transmitted from the instructor device to the remote device. The instructor-progress signal may initiate presentation of an instructor progress marker at the remote device. As presented, the instructor progress marker may indicate the currently-displayed recipe panel at the instructor device. As an example, the instructor progress marker may display a number or character associated with the specific recipe panel. As another example, the instructor progress marker may provide or reproduce a portion (e.g., all or a mere sub-portion) of the recipe panel being displayed at the instructor device (i.e., the currently-displayed panel of the instructor device). The remote user may thus be provided with an indication of what step the instructor user is currently trying to explain or perform.

Although steps 610 through 640 are described in the context of a single remote device, it is understood that the method 600 may include or be applied to multiple remote devices following the same recipe or user-guided presentation at the same time. The method 600 may thus include transmitting the recipe data packet to a second remote device spaced that is apart from the instructor device and the first remote device described above. The method 600 may also include transmitting the video signal to the second remote device, such that the real-time video feed is displayed in tandem with the user-guided presentation at the second remote device. Furthermore, the method 600 may include receiving a second user-progress signal that corresponds to a currently-displayed recipe panel at the second remote device. In response to receiving the second user-progress signal, the instructor device may present or display a second panel marker indicating the currently-displayed recipe panel at the second remote device. The second panel marker may be presented or displayed in tandem with the first panel marker, thereby allowing the instructor to know or understand what step each remote user is currently trying to understand or perform.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of directing an instructional demonstration at a remote device, the method comprising:
transmitting a recipe data packet configured to initiate a user-guided presentation of a plurality of sequenced recipe panels at the remote device;
transmitting a video signal configured to initiate a real-time video feed at the remote device in tandem with the user-guided presentation;
receiving a user-progress signal from the remote device, the user-progress signal corresponding to a currently-displayed recipe panel of the plurality of sequenced recipe panels at the remote device; and
presenting a panel marker at an instructor device spaced apart from the remote device, the panel marker indicating the currently-displayed recipe panel at the remote device.

2. The method of claim 1, wherein the currently-displayed recipe panel comprises preset legible text relating to the instructional demonstration.

3. The method of claim 1, wherein the currently-displayed recipe panel comprises a preset static image relating to the instructional demonstration.

4. The method of claim 1, wherein the currently-displayed recipe panel comprises a preset dynamic video.

5. The method of claim 1, further comprising receiving a communication-approval signal from the remote device prior to receiving the user-progress signal, the communication-approval signal granting a two-way signal exchange between the instructor device and the remote device.

6. The method of claim 1, further comprising transmitting an instructor-progress signal configured to initiate presentation of an instructor progress marker at the remote device.

7. The method of claim 1, wherein the remote device is a first remote device, and wherein the method further comprises:
transmitting the recipe data packet configured to initiate the user-guided presentation of the plurality of sequenced recipe panels at a second remote device spaced apart from the instructor device and the first remote device;
transmitting the video signal configured to initiate the real-time video feed at the second remote device in tandem with the user-guided presentation;
receiving a second user-progress signal from the second remote device, the second user-progress signal corresponding to a currently-displayed recipe panel of the plurality of sequenced recipe panels at the second remote device; and
presenting a second panel marker at the instructor device, the second panel marker indicating the currently-displayed recipe panel at the second remote device.

8. The method of claim 1, wherein the currently-displayed recipe panel is transmitted in response to a panel selection signal manually prompted by a user at the remote device.

9. The method of claim 1, wherein the remote device comprises a mobile user device.

10. The method of claim 1, wherein the remote device comprises an interactive engagement assembly mounted above a cooking appliance, the interactive engagement assembly comprising
a camera assembly positioned above the cooking appliance, and
an image monitor positioned above the cooking appliance and directed at an area forward from the cooking appliance.

11. The method of claim 1, wherein the remote device comprises a cooking appliance, the cooking appliance comprising
a cabinet defining a cooking zone, and
a heating element positioned within the cooking zone.

12. A method of directing an instructional demonstration at a first remote device and a second remote device, the method comprising:
transmitting a recipe data packet configured to initiate a user-guided presentation of a plurality of sequenced recipe panels at the first remote device and the second remote device;
transmitting a video signal configured to initiate a real-time video feed at the first remote device and the second remote device in tandem with the user-guided presentation;
receiving a first user-progress signal from the first remote device, the first user-progress signal corresponding to a currently-displayed recipe panel of the plurality of sequenced recipe panels at the first remote device;
receiving a second user-progress signal from the second remote device, the second user-progress signal corresponding to a currently-displayed recipe panel of the plurality of sequenced recipe panels at the second remote device;
presenting a first panel marker at an instructor device spaced apart from the first remote device and the second remote device, the first panel marker indicating the currently-displayed recipe panel at the first remote device;
presenting a second panel marker at the instructor device, the second panel marker indicating the currently-displayed recipe panel at the second remote device; and
transmitting an instructor-progress signal configured to initiate presentation of an instructor progress marker at the first remote device and the second remote device.

13. The method of claim 12, wherein the currently-displayed recipe panel at the first remote device or the currently-displayed recipe panel at the second remote device comprises preset legible text relating to the instructional demonstration.

14. The method of claim 12, wherein the currently-displayed recipe panel at the first remote device or the currently-displayed recipe panel at the second remote device comprises a preset static image relating to the instructional demonstration.

15. The method of claim 12, wherein the currently-displayed recipe panel at the first remote device or the currently-displayed recipe panel at the second remote device comprises a preset dynamic video.

16. The method of claim 12, further comprising receiving a first communication-approval signal from the first remote device prior to receiving the first user-progress signal, the first communication-approval signal granting a two-way signal exchange between the instructor device and the first remote device.

17. The method of claim 12, wherein the currently-displayed recipe panel at the first remote device is transmitted in response to a panel selection signal manually prompted by a user at the first remote device.

18. The method of claim 12, wherein the first remote device or the second remote device comprises a mobile user device.

19. The method of claim 12, wherein the first remote device or the second remote device comprises a interactive engagement assembly mounted above a cooking appliance, the interactive engagement assembly comprising
a camera assembly positioned above the cooking appliance, and
an image monitor positioned above the cooking appliance and directed at an area forward from the cooking appliance.

20. The method of claim 12, wherein the first remote device or the second remote device comprises a cooking appliance, the cooking appliance comprising
a cabinet defining a cooking zone, and
a heating element positioned within the cooking zone.
